(19) United States
(12) Patent Application Publication
(10) Pub. No.: US 2003/0191718 A1
(43) Pub. Date: Oct. 9, 2003

(54) Method and data processing system providing a pay-for-usage managed print service

(76) Inventor: Timothy P. Blair, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/117,860

(22) Filed: Apr. 8, 2002

(51) Int. Cl. G06F 17/60

(52) U.S. Cl. 705/51

(57) ABSTRACT

A pay-for-usage system for hard copy devices such as printers charges for actual pages printed. A pay-for-capacity system charges for a specified capacity potentially reduced by unused capacity. A pay-for-capacity or pay-for-usage system includes hard copy devices coupled to an appliance server via an internal network. Printer usage information is accumulated in these hard copy devices, periodically uploaded to the appliance server, and later forwarded to a data repository or database server across a nonsecure network such as the Internet. The customer is then billed based on this usage information.

### CROSS REFERENCE TO RELATED APPLICATIONS

This application is related to our copending patent application filed of even date herewith, assigned to Hewlett-Packard Company, and:

Titled: “METHOD AND DATA PROCESSING SYSTEM FOR A PAY-FOR-USAGE PRINT SERVICE” by Susan Marguerite Janz with attorney docket number 10012930-1.

### FIELD OF THE INVENTION

The present invention generally relates to printers.

### BACKGROUND OF THE INVENTION

The traditional model for printing from computers has been that a customer purchases a hard copy device such as a printer from a vendor. When the printer runs out of consumable supplies, such as toner and paper for a laser printer, the requisite supplies are replaced. Originally, consumable supplies were purchased from the vendor of the printer. Later however, an active after-market grew up for providing consumable supplies, most notably, for the LaserJet® printer and BubbleJet® printer manufactured by Hewlett-Packard Company, Palo Alto, Calif.

In addition to requiring consumable supplies, such as toner and paper, hard copy devices, such as printers, and their components, no matter how well constructed, wear out. For a long period of time, printers can be repaired. Again, printer repair was originally provided by the vendor, but subsequently an active after-market has emerged for printer repair. Finally, when the cost of repairing a printer exceeds its value, and printer replacement is required, in some instances, the printer is replaced with a remanufactured used printer, rather than a new printer.

There are a number of problems with the system discussed above. One of the problems is the capital investment required for the purchase of hard copy devices such as printers which typically must be capitalized and depreciated over a specified period of time—a period of time that today is often longer than the actual life span of the printers purchased. A similar problem is that the capital expended for these asset purchases often does not follow asset usage. In particular, printer usage patterns in a business or organization often do not correspond to the costs of purchasing various printers.

A related problem is that in many cases the cost of a printer does not correlate well with the use of the printer. This problem occurs because the cost of a printer may not be related to the overall usage of the printer. While a purchaser may purchase different grades and speeds of printers, the cost of these grades and speeds of printers is not a linear cost function, but rather a stepped cost function having steps of unequal size. This problem is compounded by the fact that matching printer capacity and cost to prospective usage is typically done through speculation without actual usage requirements being known. In some organizations, the problem is amplified, with the cost and grade of printer more closely a function of the perceived status of the user of the printer, rather than the actual usage of the printer. Thus, sometimes extremely expensive printers are located in a management personnel area, while less expensive printers are located in a word processing area.

Another problem is that the personnel having the responsibility for replacing consumable printer supplies often have minimal training for effectively purchasing consumable supplies. Thus, personnel purchasing consumable printer supplies often purchase consumable printer supplies at uncompetitive prices and quantities. Additionally, replacing consumables such as toner or ink cartridges can sometimes be a messy difficult job—especially if not done by someone skilled and trained for such a job.

Another related problem is that most often consumable printer supplies are not replaced until needed. This problem results in varying print quality for documents and some documents having to be printed again.

Yet another related problem is that in many instances replacement consumable printer supplies are not readily available when needed. This can again cause problems because a printing job may not be completed until these consumable supplies are replaced.

In some instances, in order to avoid making a capital investment in a printer, a printer is leased, rather than purchased. Leasing a printer has the advantage of allowing a purchaser to avoid the capital costs of purchasing a printer. All or at least a large portion of the purchase cost for a printer is typically spread out over a period of time in the lease. Similarly, the resulting out-of-pocket cash expense for leasing a printer may typically much more closely match the usage of the printer than in the case of a purchase. However, leasing a printer retains all of the other problems discussed above regarding the purchase of a printer, and typically will cost more over a period of time as compared with purchasing the asset.

In some organizations, initial or first level maintenance may typically be performed by employees. In other organizations, first level maintenance may be typically performed either by printer vendor personnel or by third-party maintenance personnel. Higher levels of maintenance support for printers typically require outside support personnel and facilities. Such support can either be provided onsite or offsite. The problem with onsite support is that it tends to be uneconomical. Also, response by outside personnel may be delayed, depriving the printer user of the use of the printer for an extended period of time. On the other hand, offsite support requires sending the printer offsite resulting in even more down time for the user of the printer.

Somewhat related to support for printers is that of support for photocopiers since both photocopiers and laser printers share the same general types of consumables, most notably toner cartridges and paper. One solution for photocopier support has been a pay-per-page (or pay-for-usage) system where a customer pays for all or a portion of the cost of the photocopier and its support on a per page printed basis. This has worked out well to overcome at least some of the problems outlined above for photocopier usage and associated costs.

Support for a photocopier on a pay-for-usage basis is typically implemented by personnel periodically visiting each photocopier to record the internal page counter information for the usage of the photocopier. If billing is monthly, each photocopier should be visited at least monthly. The usage information for each photocopier is then compared with the usage information from the preceding period to determine how many pages have been copied or printed during this last period.

However, despite similar appearances, there are significant differences between printer usage and photocopier usage. The most apparent difference is that there tend to be significantly more printers than photocopiers in most organizations. Most printers tend to be inexpensive, whereas the photocopiers tend to be significantly more expensive. This can result in the staff using a photocopier tending to have more experience and training than the staff using a printer.

Another problem is that printers are small, numerous, and easy to move. Printers can typically be attached to any computer with the requisite port to a local area network. Thus, it is not be uncommon for printers that have been leased to be moved, making locating any given printer during any regular interval to obtain its usage information expensive, time consuming, and mistake prone.

Compounding this problem for printers is the fact that they are typically more numerous than photocopiers. Thus, it is much harder to justify the cost of periodically determining printer usage counts—assuming that each printer can be located when desired. Also, currently most printers, for cost reasons, do not have visible page counters. Thus, while leasing photocopiers works well, it will not work very well for a large number of printers distributed over an area.

Another problem that the photocopier pay-per-page lease business model does not adequately address for leasing printers is a problem associated with the replacement of consumable supplies, such as toner for laser printers. Unless the personnel periodically reading page counts manually inspects toner cartridges, it is likely that toner cartridges will frequently run out, invariably at precisely the wrong times during printing.

For all of these reasons, it would be advantageous to have a system available in which printer costs can be tied closely to actual printer utilization, where the system is extremely reliable, and that the system down time can be minimized.

### SUMMARY OF THE INVENTION

A pay-for-usage system for hard copy devices charges a user for the actual number of pages printed over a specified period of time. A pay-for-capacity system periodically charges a user for a specified print capacity, with this charge potentially reduced for printing less than a specified number of pages during a period of time.

A pay-for-usage system or a pay-for-capacity system includes hard copy devices such as printers coupled to an appliance server via an internal network. Printer usage information is accumulated in these printers, periodically uploaded to the appliance server, and later forwarded to a data repository or database server across a nonsecure network such as the Internet. The customer is then billed based on this usage information for the actual amount of printing performed or for agreed-to capacity potentially less some of the capacity not used based on this usage information.

### BRIEF DESCRIPTION OF THE DRAWINGS

FIG. 1 is a block diagram illustrating a pay-for-usage system, in accordance with one embodiment of the present invention;

FIG. 2 is a perspective view of the internal structure illustrating an exemplary laser printer as shown in FIG. 1;

FIG. 3 is a block diagram illustrating the printer controller shown in FIG. 2;

FIG. 4 is a block diagram illustrating a General Purpose Computer, such as the server shown in FIG. 1;

FIG. 5 is a flowchart illustrating partial exemplary operation of a hard copy device, in accordance with one embodiment of the present invention; and

FIG. 6 is a flowchart illustrating partial exemplary operation of an appliance server 86, in accordance with one embodiment of the present invention.

### DETAILED DESCRIPTION OF THE INVENTION

A pay-for-usage system results in a customer being charged for the actual number of pages printed by a hard copy device over a specified period of time. A strict pay-for-capacity system charges a customer for a specified capacity for printing. However, quite often customers will not print as many pages over a specified period of time as are possible for their contract capacity. The same type of hard copy device usage information collected for a pay-for-usage system can also be utilized in a pay-for-capacity system to reduce the cost to the customer by an amount based on unused capacity. The term “pay-for-usage” as used herein includes both the pay-for-usage and pay-for-capacity systems described above plus other alternatives that utilize actual hard copy device utilization information for billing purposes.

A pay-for-usage system for hard copy devices such as printers is disclosed herein. Each hard copy device in the system accumulates its own usage information, such as how many pages have been printed and how much consumable supplies have been consumed. A snapshot of this information is then uploaded to an appliance server periodically and upon command. This information for each hard copy device is then consolidated with that of other hard copy device utilizing that appliance server, and the consolidated usage information is then uploaded to a server. Customers are then billed on a periodic basis as required, utilizing the hard copy device usage information collected such as the actual amount of pages printed and/or consumable supplies utilized.

Since snapshots of the hard copy device usage information are uploaded electronically, it is not necessary for anyone to physically periodically inspect each hard copy device in this pay-for-usage system, as is necessary with similar photocopy systems. It also allows hard copy devices to be moved without potentially losing access to their usage information.

Another advantage is that the level of consumable supplies, such as laser printer toner and ink jet cartridges, can be monitored. Then, when these consumable supplies dwindle, they can be replaced proactively. This provides the ability to have trained technicians periodically replace these supplies on a number of hard copy devices at the same time, without the necessity of checking each hard copy device for its current levels of supplies.

Since consumable supply levels are being accumulated along with pages printed for each hard copy device, another advantage is that these numbers can be compared for each hard copy device and for expected usages. Then, when a hard copy device starts utilizing an abnormal quantity of consumable supplies, the hard copy device can be inspected, repaired, or even replaced. In the past, this strategy was contrary to the standard business plan of printer vendors, who typically made more money on consumable supplies than on the hard copy device that used the supplies. But in the present invention, it provides for additional savings since in a pay-for-usage system, the same vendor is paying for both the hard copy devices and their consumable supplies.

Another advantage of the present invention in a pay-for-usage system is that accumulating and consolidating hard copy device usage information allows a vendor to increase its service level by adding hard copy devices or upgrading hard copy device levels when a printer or a group of hard copy devices show higher than expected usage. Alternatively, hard copy devices can be removed or hard copy device levels reduced when they are underutilized. Indeed, in an alternate embodiment, hard copy device usage information is accumulated on a per-user per-hard copy device basis. Then, hard copy device users can be periodically reallocated to hard copy devices to achieve optimal service levels at minimum prices.

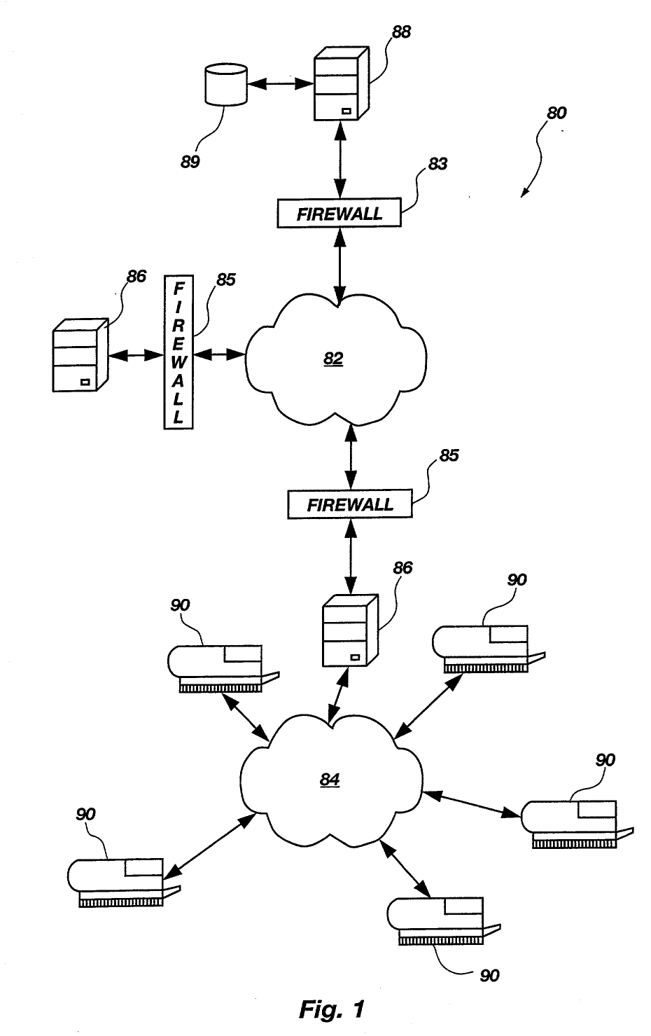

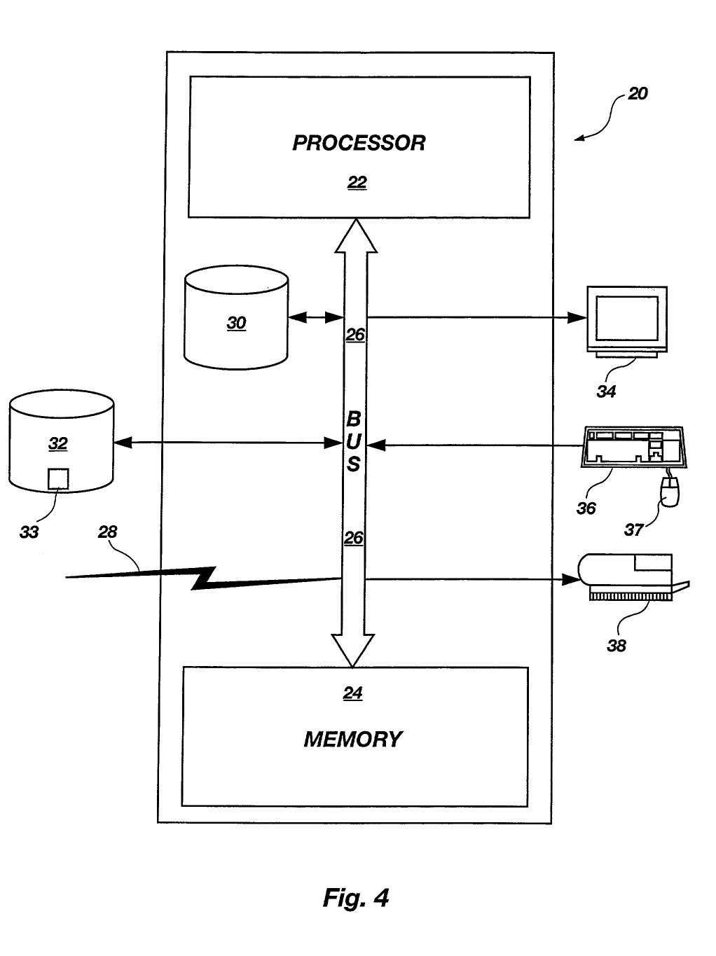

FIG. 1 is a block diagram illustrating a pay-for-usage system 80, in accordance with one embodiment according to the present invention. The system 80 includes two networks: the Internet 82 (first network) and a corporate intranet 84 (second network). This is for illustrative purposes only of the present invention. Also within the present invention are other types of networks, including a single shared network. Coupled to the first network 82 is a server 88 protected by a firewall 83. The server 88 includes a database store 89, preferably comprising non-volatile storage media (see FIG. 4). Also coupled to the first network 82 are one or more appliance servers 86 protected from the Internet 82 by a firewall 85.

The server 88 preferably communicates with the appliance servers 86 across the Internet 82 and through the firewalls 83, 85 utilizing encrypted e-mail. In one embodiment a private key/public key encryption system is utilized, such as PGP. Alternatively, other methods of encryption are also within the scope of the present invention. Also, other methods of secure communications are within the scope of the present invention, such as the use of virtual private networks (VPN). In one embodiment, security is further enhanced by utilizing a key or hash to authenticate each appliance server 86 and/or hard copy device attached to such. In one, an MD5 hash code is utilized for this authentication. One alternative is to use the secure hash algorithm (SHA) from NSA/NIST. Other hash functions and methods of authentication are also within the scope of this invention.

In the embodiment illustrated in FIG. 1, the second network 84 is a corporate intranet protected from the Internet 82 by use of a firewall 85. Coupled to and communicating over the second network 84 with the appliance server 86 are a plurality of hard copy devices such as printers 90. In the embodiment illustrated in FIG. 1, the printers 90 are shown directly connected to the second network 84. These printers 90 are preferably directly connected to the second network 84, such as by utilizing JetDirect® cards installed in printers 90 sold by Hewlett-Packard Company, Palo Alto, Calif. However, in other embodiments of the present invention, some or all of the printers 90 utilize other means to connect to the second network 84, including through print servers and through other computers (not shown), such as is often found today utilizing a parallel/Centronics® interface. Shown coupled to the second network 84 and communicating over the first network 82 is an appliance server 86. Other configurations are within the present invention as long as it is possible to communicate between the server 88 and the appliance servers 86, and between the appliance servers 86 and the printers 90. One such embodiment that might be used for smaller customers is to have printers 90 act as the appliance servers 86.

In one embodiment according to the present invention, the server 88 is a general-purpose computer (see FIG. 4). It acts as a repository for configuration information received from the appliance servers and utilization information received from the printers 90. As such, it is preferably reasonably fault-tolerant. Note that in the embodiment of the present invention of FIG. 1, both functions are shown in the same server 88. However, in other embodiments of this invention, these two functions (collection of usage information and storage of appliance server configurations) can be performed in separate servers 88. The configuration information and utilization information is stored in the database store 89 portion of the server 88.

The appliance servers 86 may be general-purpose computers, typically configured without a screen or keyboard, except possibly for emergency work. Other configurations are also within the scope of the present invention, such as incorporating this functionality within a hard copy device. The appliance servers 86 are utilized to collect usage information from the printers 90 and to relay such to a server 88.

The hard copy device configurations supported by each appliance server 86 are stored on the server 88. One of the purposes of this is to allow an appliance server 86 to be rapidly replaced should it ever fail. It can be hot-swapped if necessary, or one or more hot spares may be maintained. When a replacement appliance server 86 is hot-swapped or activated, the corresponding hard copy device configuration that it is to support is downloaded from the server 88 where it had been stored. Such hard copy device configurations are preferably uploaded from appliance servers 86 to the servers 88 for storage whenever modified and periodically (for example, on a daily basis).

The printers 90 shown in the embodiment of the present invention of FIG. 1 may include laser printers, ink jet printers, and All-in-One FAX/scanner/printers. The printers 90 provide the ability to accumulate and store usage information. This includes the number of pages printed, the number of duplex pages not printed, and the amount of consumable supplies utilized and/or available. The number of pages printed is preferably accumulated and maintained in a software register or variable. In the case of a duplex printer, a count of blank pages printed is also preferably accumulated and maintained in order to provide billing of customers for only the actual number of pages printed. Snapshots of this usage information are then uploaded to an appliance server 86 periodically and/or upon demand. In one embodiment, this upload is done in response to requests from the appliance server 86. In one embodiment of the present invention, the printers 90 can also provide alerts to the appliance servers 86 when the printers 90 run low (or out) of consumable supplies, such as toner or ink cartridges. Both the accumulation of this information, as well as providing the alerts, provides the ability to replace these consumable supplies proactively.

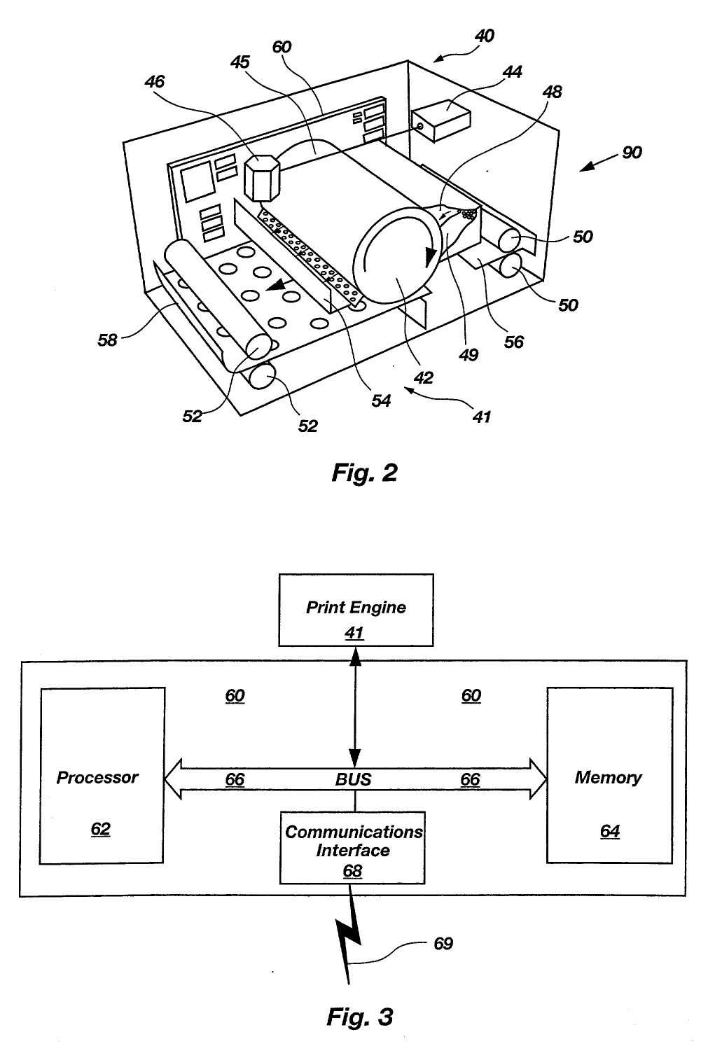

FIG. 2 is a perspective view of the internal structure illustrating an exemplary laser printer 90 as shown in FIG. 1. In order to print a page on a laser printer 40, print information defining the page to be printed is transferred across a communications link 69 (see FIG. 3) from a print source, such as from a general purpose computer 20 (see FIG. 4), to a printer controller 60. In the printer controller 60, the print information received is converted into a bitmap image corresponding to dots on the page to be printed. A letter-sized page printed at 600 dots per inch results in over 30 million dots. This bitmap image of dots to be printed is stored in the memory of the printer controller 60.

The remainder of the laser printer 40 (excluding the printer controller 60) comprises the print engine 41. At the heart of the laser printer 40 is a rotating drum 42—an organic photo-conducting cartridge (OPC)—with a coating that allows it to hold a negative electrostatic charge. A laser beam 45 scans across the surface of the drum 42, selectively discharging points on the surface of the drum 42 resulting in points of positive charge on the drum's surface that will ultimately represent the output image. The selective discharging is done by turning the laser 44 on and off as it scans the rotating drum 42, using a complex arrangement of spinning mirrors 46 and lenses. The printer controller 60 controls the laser 44 and the spinning mirrors 46 to discharge a pattern on the drum 42 corresponding to the bitmap of dots stored in its memory.

A line of charged and discharged areas on the drum 42 corresponds to a line of white and colored dots of the sheet of the print medium onto which the image will eventually appear, every point in the line on the drum corresponding to a point on the sheet of the print medium 56. In the meantime, the sheet of print medium 56 is passed adjacent to an electrically charged wire (not shown), which deposits a negative charge onto it.

Inside the printer, the drum 42 rotates to build one horizontal line at a time. As the drum 42 rotates to present the next area for laser treatment, the written-on area moves into the laser toner 48. Toner is typically a very fine colored powder, negatively charged so as to cause it to be attracted to the points of positive charges on the drum 42 surface. For example, black toner is typically utilized for black and white printing. Toner is typically applied to the drum 42 by use of a toner roller 49. Thus, after a full rotation, the drum's surface may contain the whole of the required black image.

A sheet of printer medium 56 then comes into contact with the drum 42, fed in by a set of rubber rollers 50. As the drum 42 completes its rotation, the toner is transferred from the drum 42 to the sheet of printer medium 56 by virtue of its magnetic attraction, thereby transferring the image to the sheet of printer medium 56. Negatively charged areas of the drum 42 don't attract toner and result in white areas on the imaged paper 58. Toner is specially designed to melt very quickly. A fusing system consisting of fusing rollers 52 then applies heat and pressure to the imaged printer medium 58 in order to adhere the toner permanently. The final stage is to clean the drum 42 of any remnants of toner utilizing a cleaning system 54, ready for the cycle to start again.

FIG. 3 is a block diagram illustrating the printer controller 60 shown in FIG. 2. The printer 90 illustrated in FIG. 2 is a laser printer. This is illustrative only for the embodiment described in FIG. 2. The present invention includes other types of printers with printer controllers 60 providing similar functionality. The printer controller 60 is utilized to control the printer engine 41. The printer controller 60 includes a processor 62 coupled via a bus 66 to a memory 64. The processor 62 may be a custom microcontroller or a commodity microprocessor. The processor 62 in one embodiment of the present invention comprises a MIPS® RISC processor. However, other types of processors and microcontrollers are also within the scope of the present invention. The memory 64 preferably includes a combination of volatile memories such as DRAM and SRAM and non-volatile memories such as Flash or EEPROM memories.

The printer controller 60 executes as a Java® Virtual Machine (JVM) in one embodiment of the present invention. The counts utilized in each printer to accumulate usage and consumable supply information are thus accumulated in and stored as Java variables in the JVM. Snapshots in time of these variables can then be uploaded to an appliance server 86. This uploading may be done upon command or on a periodic basis. Other types of software control of printer controller 60 are also within the scope of the present invention. For example, the Linux® operating system is able to execute on the MIPS® RISC processor in one embodiment of the present invention. In that case, accumulation of usage information may be done utilizing commodity software languages such as C and C++.

Also coupled to the bus 66 is the printer engine 41 and a communications interface 68. The printer controller 60 controls the operation of the printer engine 41, including controlling operation of the laser 44, spinning mirrors 46, and paper feed. The communications interface 68 is coupled to one or more communications links 69. Typical types of communications links 69 are an RS-232 Centronics® interface or to a network, such as Ethernet. Other types of communications links 69 and interfaces 68 are also within the scope of this invention.

FIG. 4 is a block diagram illustrating a general purpose computer 20, such as the server 88 and appliance servers 86 shown in FIG. 1. The general purpose computer 20 has a computer processor 22 and memory 24, connected by a bus 26. Memory 24 is a relatively high-speed machine-readable medium and includes volatile memories, such as DRAM, SRAM, and non-volatile memories, such as ROM, FLASH, EPROM, EEPROM, and bubble memory. Also connected to the bus 26 are secondary storage 30, external storage 32, output devices such as a monitor 34, input devices such as a keyboard 36 with a mouse 37, and printers 38. Secondary storage 30 includes machine-readable media such as hard disk drives, magnetic drum, and bubble memory. External storage 32 includes machine-readable media such as floppy disks, removable hard drives, magnetic tape, CD-ROM, and even other computers, possibly connected via a communications line 28. The distinction drawn here between secondary storage 30 and external storage 32 is primarily for convenience in describing the invention. As such, it should be appreciated that there is substantial functional overlap between these elements. Computer software 33 such as test programs, operating systems, and user programs can be stored in a computer instruction storage medium, such as memory 24, secondary storage 30, and external storage 32. Executable versions of computer software 33, such as pay-for-usage billing software, can be read from a computer readable medium such as external storage 32, secondary storage 30, and non-volatile memory and loaded for execution directly into volatile memory, executed directly out of non-volatile memory, or stored on the secondary storage 30 prior to loading into volatile memory for execution.

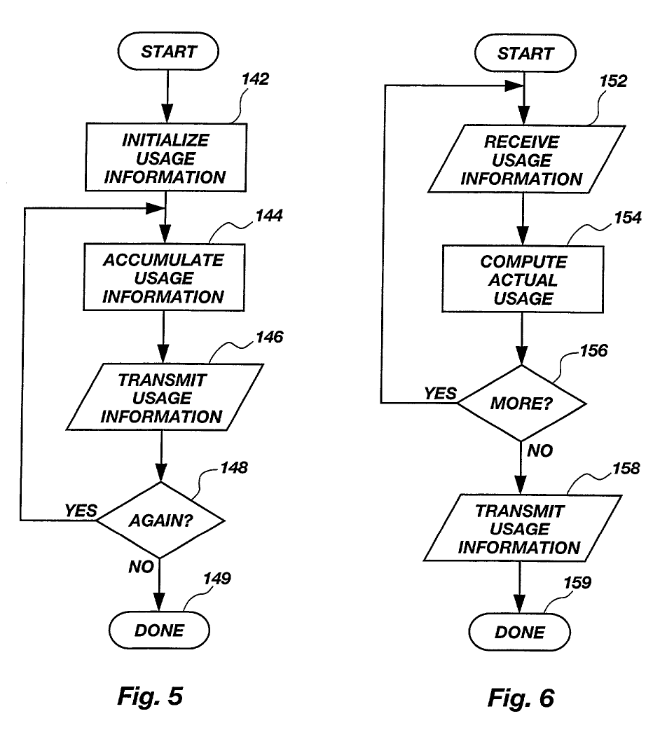

FIG. 5 is a flowchart illustrating partial exemplary operation of a hard copy device, in accordance with one embodiment of the present invention. Starting, usage information for the hard copy device is initialized, step 142. The initialization may for example be on a periodic basis or may be in response to a request by an appliance server. Then, a loop is entered, and usage information is accumulated, step 144. Some examples of usage information that can be maintained in a hard copy device are pages printed and duplex pages not printed. Then, a snapshot of the usage information is transmitted to an appliance servers 86, step 146. A snapshot is the status of counters and/or variables used to accumulate usage information at some point in time. This transmission may for example be on a periodic basis or upon command from another source, such as appliance servers 86. A test is then made whether to accumulate more usage information, step 148, and if more usage information is to be accumulated, the loop repeats, starting with the accumulation of usage information, step 144. Otherwise, the operation is complete, step 149.

The operation illustrated in FIG. 5 is illustrative, and other modes of operation are also within the scope of the present invention. For example, the variables and/or counters utilized to accumulate usage information, step 144, may be initialized whenever a snapshot is taken of them or when a snapshot of usage information is transmitted, step 146. Also, the operation shown in FIG. 5 shows a test for continuing to accumulate usage information. However, in typical operation, a hard copy device will continue to operate indefinitely, periodically or upon command transmitting usage information, step 146.

FIG. 6 is a flowchart illustrating partial exemplary operation of an appliance server 86, in accordance with one embodiment of the present invention. Periodically or upon command, the appliance server 86 will accumulate usage information from one or more hard copy devices. A loop is entered, and a snapshot of usage information for a hard copy device is received, step 152. The transmission of usage information from the hard copy device may be as a result of a command from for example the appliance server 86 or may be on a periodic basis. If necessary, actual usage information may be computed, step 154. This may be done by subtracting previous usage information values for this hard copy device from the usage information just received. A test is then made whether or not more hard copy devices will be transmitting their usage information to the appliance server 86, step 156. If more hard copy devices will be transmitting their usage information to the appliance server 86, the loop is repeated, starting with the receiving of the usage information from another hard copy device, step 152. Otherwise, the usage information from the hard copy devices that has been received is consolidated and the consolidated usage information for all of the hard copy devices is transmitted to the server 88, step 158. The partial exemplary operation of the appliance server 86 is now complete, step 159.

In one embodiment of the present invention, the transmission of usage information from an appliance server 86 to a server 88 is across the Internet 82. In order to protect the usage information, one or more messages containing such may be encrypted by for example utilizing public key/private key encryption. Alternatively or additionally, a hash key may be transmitted in a message to the server 88 in order to validate that the usage information corresponds to a specific hard copy device or that the usage information is being transmitted by a specific appliance server 86.

Those skilled in the art will recognize that modifications and variations can be made without departing from the invention. Therefore, it is intended that this invention encompass all such variations and modifications as fall within the scope of the appended claims.

What is claimed is:

1. A method of providing a pay-for-usage print service, said method comprising:
accumulating a usage count for a first hard copy device;
transmitting a first snapshot of the usage count for the first hard copy device to a first appliance server; and
transmitting the first snapshot of the usage count from the first appliance server to a server.

2. The method in claim 1, further comprising:
transmitting a second snapshot of the usage count for the first hard copy device to the first appliance server; and
transmitting the second snapshot of the usage count from the first appliance server to the server.

3. The method in claim 2, further comprising:
computing a difference between the second snapshot of the usage count for the first hard copy device and the first snapshot of the usage count for the first hard copy device to generate a usage amount for the first hard copy device; and
billing a customer for the usage amount for the first hard copy device.

4. The method in claim 1, further comprising:
accumulating a usage count for a second hard copy device;
transmitting a first snapshot of the usage count for the second hard copy device to the first appliance server; and
transmitting the first snapshot of the usage count for the second hard copy device from the first appliance server to the server.

5. The method in claim 4, further comprising:
transmitting a second snapshot of the usage count for the first hard copy device to the first appliance server; and
transmitting the second snapshot of the usage count from the first appliance server to the server.

6. The method in claim 1, further comprising:
accumulating a usage count for a second hard copy device;
transmitting a first snapshot of the usage count for the second hard copy device to a second appliance server; and
transmitting the first snapshot of the usage count for the second hard copy device from the second appliance server to the server.

7. The method in claim 1, wherein transmitting the first snapshot of the usage count from the first appliance server to a server comprises:
transmitting the first snapshot of the usage count for the first hard copy device across a first firewall to an Internet.

8. The method in claim 7, wherein transmitting the first snapshot of the usage count from the first appliance server to a server further comprises:
receiving the first snapshot of the usage count for the first hard copy device across a second firewall from the Internet.

9. The method in claim 1, wherein transmitting the first snapshot of the usage count from the first appliance server to a server comprises:
encrypting a message containing the first snapshot of the usage count for the first hard copy device utilizing a public key/private key encryption.

10. The method in claim 1, wherein transmitting the first snapshot of the usage count from the first appliance server to a server comprises:
including a hash key in a message containing the first snapshot of the usage count for the first hard copy device in order to validate an identity of the first hard copy device.

11. A appliance server capable of providing a pay-for-usage print service comprising:
a computer instruction storage medium containing computer instructions for:
receiving a first snapshot of a usage count from a first hard copy device; and
transmitting the first snapshot of the usage count from the first hard copy device in a message to a server.

12. The appliance server in claim 11, wherein the computer instruction storage medium further contains computer instructions for:
receiving a first snapshot of a usage count from a second hard copy device; and
transmitting the first snapshot of the usage count from the second hard copy device to the server.

13. The appliance server in claim 12, wherein the computer instruction storage medium further contains computer instructions for:
consolidating the first snapshot of the usage count from the first hard copy device with the first snapshot of the usage count from the second hard copy device prior to transmitting the first snapshot of the usage count from the first hard copy device with the first snapshot of the usage count from the second hard copy device to the server.

14. The appliance server in claim 11, wherein the computer instruction storage medium further contains computer instructions for:
receiving a second snapshot of the usage count from the first hard copy device; and
transmitting the second snapshot of the usage count from the first hard copy device to the server.

15. The appliance server in claim 14, wherein the computer instruction storage medium further contains computer instructions for:
computing a difference between the second snapshot of the usage count from the first hard copy device and the first snapshot of the usage count from the first hard copy device to generate a usage amount for the first hard copy device.

16. The appliance server in claim 11, wherein the computer instruction storage medium further contains computer instructions for:
transmitting a request to the first hard copy device to transmit the first snapshot of the usage count from the first hard copy device to the appliance server.

17. The appliance server in claim 11, wherein the computer instruction storage medium further contains computer instructions for:
transmitting a request to the first hard copy device to initialize the usage count from the first hard copy device.

18. The appliance server in claim 11, wherein the computer instruction storage medium further contains computer instructions for:
encrypting the first snapshot of the usage count from the first hard copy device before transmitting the message to the server.

19. The appliance server in claim 11, wherein the computer instruction storage medium further contains computer instructions for:
computing a hash code for a potion of the message before transmitting the message to the server.

20. A computer readable medium having computer readable instructions for
receiving a first snapshot of a usage count from a hard copy device; and
transmitting the first snapshot of the usage count from the hard copy device in a message to a server.
